(19) United States
(12) Patent Application Publication
(10) Pub. No.: US 2013/0039754 A1
(43) Pub. Date: Feb. 14, 2013

(54) VERTICAL DOUBLE-SUCTION PUMP HAVING BENEFICIAL AXIAL THRUST

(71) Applicants: Paul W. BEHNKE, Seal Beach, CA (US); Matthew J. KOREN, Los Angeles, CA (US)

(72) Inventors: Paul W. BEHNKE, Seal Beach, CA (US); Matthew J. KOREN, Los Angeles, CA (US)

(73) Assignee: ITT, Wilmington, DE (US)

(21) Appl. No.: 13/207,473

(22) Filed: Aug. 11, 2011

(51) Int. Cl. F03B 11/02

(52) U.S. Cl. 415/208.1

(57) ABSTRACT

Apparatus, including a vertical double-suction pump, is provided featuring a pump casing and a double suction impeller arranged therein on a shaft. The pump casing has a pump casing wall. The double suction impeller has upper and lower shrouds with metal rims configured to form upper and lower isolating annuli between the double suction impeller and the wall of the pump casing in order to impede a recirculation flow from an impeller discharge to be able to act of the upper and lower shrouds and create a controlled axial thrust load from differentiated hydraulic pressure on the upper and lower shrouds. The upper and lower isolating annuli may also be geometrically varied between the upper and lower shrouds of the double suction impeller to create a pressure differential in a direction parallel to an axis of rotation of the double suction impeller.

### BACKGROUND OF THE INVENTION

1. Field of the Invention

The present invention relates to a pump or pumping assembly, arrangement or combination; and more particularly relates to a new technique for providing axial thrust in such a pump or pumping assembly, arrangement or combination, e.g., including a vertical double-suction pump.

2. Brief Description of Related Art

Single-suction type impellers produce hydraulic thrust loads in the direction along their axis of rotation. In a vertically suspended pump, these axial thrust loads are transmitted from the impeller(s) at the bottom of the pump rotor assembly, through the shaft of the pump, and absorbed by a thrust bearing in the motor at the top of the pump. Axial thrust loads are beneficial in vertical pumps for two reasons:
1) Axial thrust loads applied to pump shafts in tension increase the rotor dynamic stiffness of the rotor system.
2) Axial thrust loads applied to pump shafts improve the internal alignment of the pump rotating elements to stationary elements.

Typical double-suction type impellers produce no axial thrust loads from hydraulic forces; because their symmetrical geometry about the centerline of the impeller has the same pressure acting on both shrouds. Therefore, when typical double-suction impellers are used in vertically suspended pumps, the benefits of axial thrust loads pump shafts are not realized, and these types of pumps suffer from poor reliability.

In view of the aforementioned, there is a long felt need in the industrial pump industry for an improved design or technique that solves the problems related to realizing axial thrust loads in an industrial pump or pumping assembly, arrangement or combination, including a vertical double-suction pump.

### SUMMARY OF THE INVENTION

According to some embodiments of the present invention, apparatus, including for example a vertical double-suction pump, is provided featuring a pump casing and a double suction impeller arranged therein on a shaft. The pump casing has a pump casing wall. The double suction impeller has upper and lower shrouds with metal rims configured to form upper and lower isolating annuli or rings between the double suction impeller and the pump casing wall of the pump casing in order to impede a recirculation flow from an impeller discharge to be able to act upon the upper and lower shrouds and create a controlled axial thrust load from differentiated hydraulic pressure on the upper and lower shrouds.

In effect, the present invention provides a special double-suction type impeller design, which creates the controlled axial thrust load from differentiated hydraulic forces acting on the impeller shrouds. The metal rims or rings on the upper and lower shrouds of the double-suction impeller design create or form the isolating annuli or rings between the double suction impeller and the pump casing wall. The isolation occurs as a result of the metal rim impeding the recirculation flow from the impeller discharge to be able to act upon the upper and lower impeller shrouds. The upper and lower isolating annuli or rings may be geometrically varied between the upper and lower shrouds of the impeller, which creates a pressure differential in the direction parallel to the axis of impeller rotation. Thus axial thrust load is created on a double-suction impeller design which normally has no substantial hydraulic thrust load in the direction of the axis of rotation.

When this innovative double-suction type impeller design is used in vertically suspended pumps, the benefits are at least as follows:
Axial thrust loads applied to pump shafts in tension increase the rotor dynamic stiffness of the rotor system and thereby improve pump reliability.
Axial thrust loads applied to pump shafts in tension improve internal alignment of the pump rotor and casing and thereby improve wear life of bearings and shafts.
Incorporating a pair of isolating annuli between the impeller and pump casing wall reduces internal leakage in the pump, which improves volumetric efficiency and overall pump efficiency.
Incorporating a pair of isolating annuli between the impeller and pump casing wall dampens secondary flows from pump casing recirculation and isolates such flows from buffeting the shrouds of the impeller. This mitigates undesirable axial vibration on the pump rotor system.
The metal ring which makes up the isolation annuli on the impeller is located at the minimum trim value of the impeller outside diameter. This allows the impeller to have a variety of trim diameters without compromising the benefits of the invention.

### BRIEF DESCRIPTION OF THE DRAWING

The drawing includes the following Figures, not necessarily drawn to scale:

FIG. 1 is a partial cross-sectional view of apparatus in the form of a vertical double-suction pump having beneficial thrust according to some embodiments of the present invention.

FIG. 2 is a partial cross-sectional view of the lower part of the apparatus shown in FIG. 1.

FIG. 3 is a top perspective view of a double suction impeller according to some embodiments of the present invention.

In the following description of the exemplary embodiment, reference is made to the accompanying Figures in the drawing, which form a part hereof, and in which is shown by way of illustration of an embodiment in which the invention may be practiced. It is to be understood that other embodiments may be utilized, as structural and operational changes may be made without departing from the scope of the present invention.

### DETAILED DESCRIPTION OF THE INVENTION

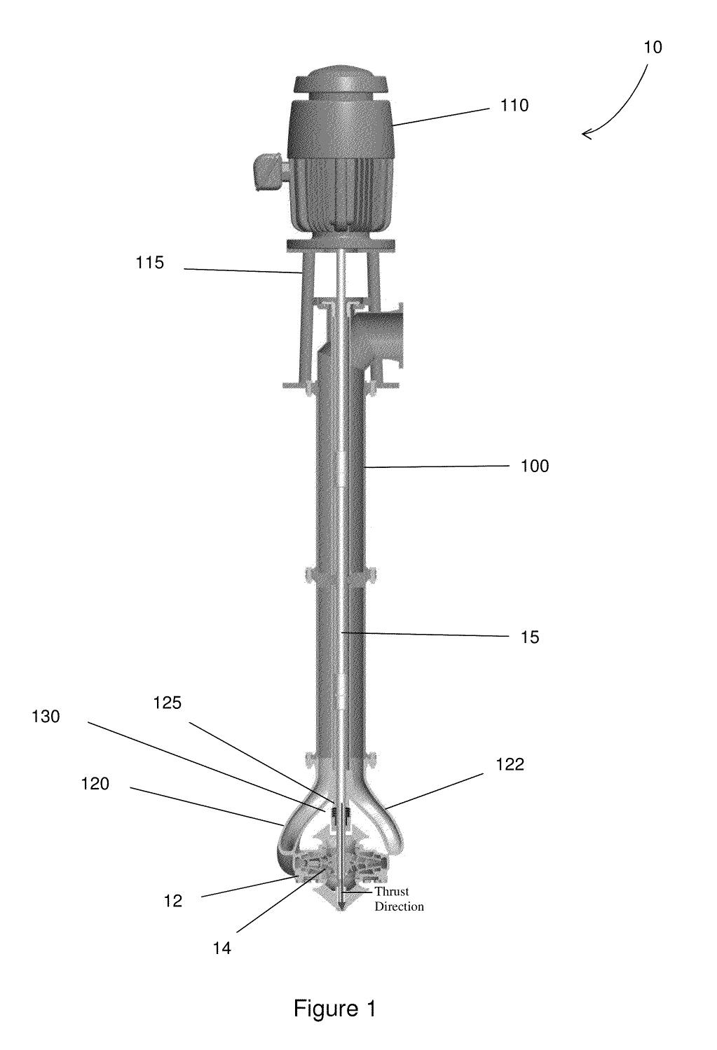

FIG. 1 shows apparatus generally indicated as 10 according to some embodiments of the present invention in the form of a vertical double-suction pump. While the present invention will be described by way of example in relation to such a vertical double-suction pump, the scope of the invention is not intended to be limited to the type or kind of pump, pumping assembly, arrangement or combination. For example, embodiments are envisioned in which the present invention is implemented in other types or kinds of pumps, pumping assemblies, arrangements or combinations either now known or later developed in the future.

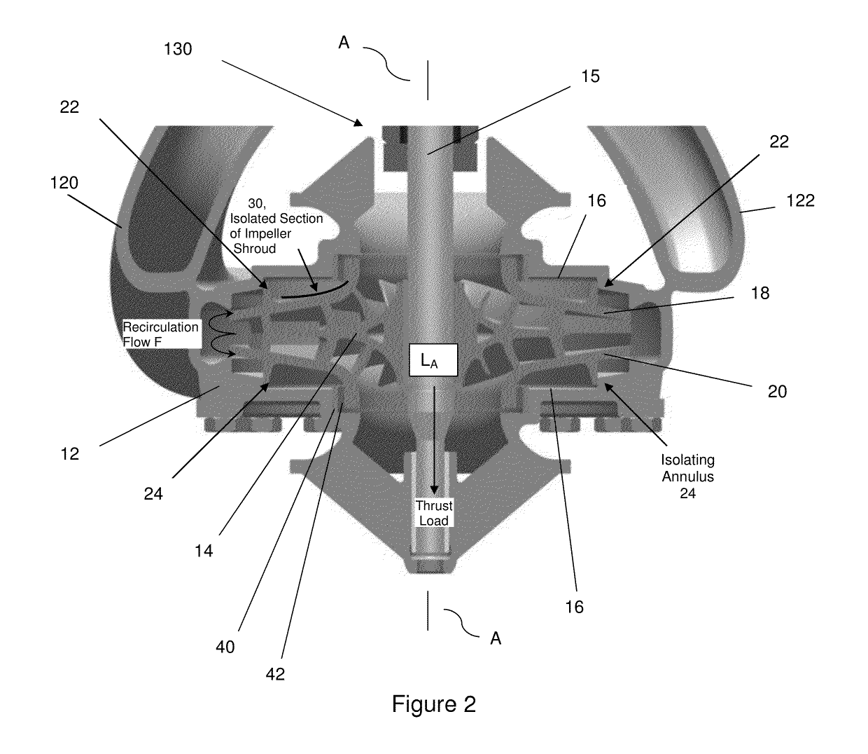

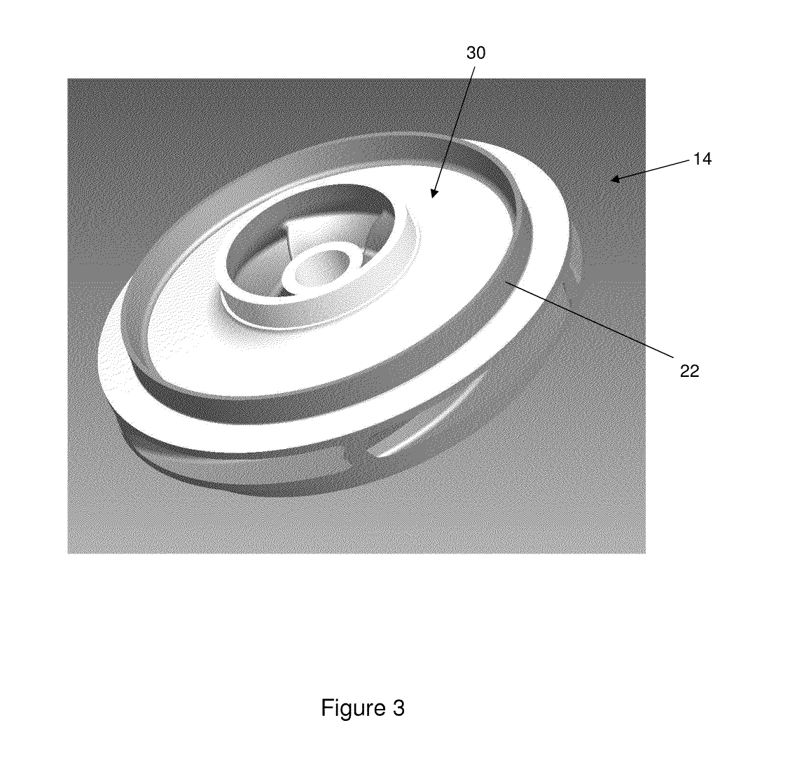

In FIGS. 1 and 2, the vertical double-suction pump 10 includes a pump casing 12 and a double suction impeller 14 (see FIG. 3) arranged therein on a shaft 15. The pump casing 12 has a pump casing wall 16. The double suction impeller 14 has upper and lower shrouds 18 and 20 with metal rims 22 and 24 configured to form upper and lower isolating annuli between the double suction impeller 14 and the pump casing wall 16 of the pump casing 12 in order to impede a recirculation flow F from the impeller discharge 120, 122 to be able to act upon the upper and lower shrouds 18 and 20, and create a controlled axial thrust load L_{A} from differentiated hydraulic pressure on the upper and lower shrouds 18 and 20 of the double suction impeller 14 within corresponding isolated sections 30 located above and below the impeller 14. The isolated sections 30 are established by the isolating annuli 22 and 24 and pump wearing rings 40, 42.

In operation, the pair of isolating annuli 22 and 24 between the double suction impeller 14 and pump casing wall 16 reduces internal leakage in the pump 10, which improves volumetric efficiency and overall pump efficiency, and also dampens secondary flows from pump casing recirculation and isolates such flows from buffeting the upper and lower shrouds 18 and 20 of the double suction impeller 14. This mitigates undesirable axial vibration on the overall pump rotor system of the apparatus 10.

According to some embodiments, the upper and lower isolating annuli 22 and 24 may also be geometrically varied between the upper and lower shrouds 18 and 20 of the double suction impeller 14 to create a pressure differential in a direction parallel to an axis A of rotation of the double suction impeller 14.

The upper and lower isolating annuli 22 and 24 may be configured to create the controlled axial thrust load L_{A} on the double suction impeller 14 which typically has substantially no hydraulic thrust load in the direction of the axis A of rotation.

The upper and lower isolating annuli 22 and 24 may be configured to form an isolated section generally indicated by arrow 30 along the upper or lower shrouds 18 and 20 extending at least partly towards the shaft 15. (In FIG. 2, the isolation section 30 of the upper impeller shroud 18 is identified by the dark line pointed to by arrow 30, and the lower impeller shroud 20 is understood to have a similar isolation section that is configured and formed by the lower isolating annuli 24.

The metal rims 22 and 24 may be configured to be located at a minimum trim value in relation to the outside diameter of the double suction impeller 14, as shown, e.g., in FIG. 2. However, the scope of the invention is not intended to be limited to the specific configuration, height or location of the metal rims 22 and 24 shown in FIG. 2. For example, embodiments are envisioned in which the metal rims 22 and 24 are configured or located on the upper and lower shrouds 18 and 20 at a different location than that shown, e.g., in FIG. 2, including being configured on the upper and lower shrouds 18 and 20 closer to the outside diameter nearer impeller discharges 120, 122, or including being configured on the upper and lower shrouds 18 and 20 closer to its inner periphery nearer the shaft 15. The metal rims 22 and 24 are configured at a specific location on the upper and lower shrouds 18 and 20 and with a sufficient height so as to impede the recirculation flow F from the impeller discharge 120, 122 to be able to act upon the upper and lower shrouds 18 and 20, and create the controlled axial thrust load L_{A} from differentiated hydraulic forces on the upper and lower shrouds 18 and 20. As shown, the metal rims 22 and 24 are configured to extend substantially completely around the upper or lower shrouds 18 and 20.

Moreover, the apparatus 10, e.g., as shown in FIGS. 1 and 2, also includes other elements or components that do not form part of the underlying invention described herein, as would be appreciated by a person skilled in the art, and thus are not described in detail herein, including a discharge piping assembly 100, a motor assembly 110 arranged on a motor mounting assembly 115 and coupled to the shaft 15, the impeller discharges 120, 122 coupled between the pump casing 12 and a discharge piping assembly 100, a bellows type mechanical face sealing arrangement arranged between a casing assembly 125 and the shaft 15 and generally indicated by an arrow 130 that forms part of another patent application by the instant inventors, etc.

### The Scope Of The Invention

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What we claim is:

1. Apparatus, including a vertical double-suction pump, comprising:
a pump casing having a pump casing wall; and
a double suction impeller arranged in the pump casing on a shaft, and having upper and lower shrouds with metal rims configured to form upper and lower isolating annuli between the double suction impeller and the wall of the pump casing in order to impede a recirculation flow from an impeller discharge to be able to act upon the upper and lower shrouds and create a controlled axial thrust load from differentiated hydraulic pressure on the upper and lower shrouds.

2. Apparatus according to claim 1, wherein the upper and lower isolating annuli are geometrically varied between the upper and lower shrouds of the double suction impeller to create a pressure differential in a direction parallel to an axis of rotation of the double suction impeller.

3. Apparatus according to claim 2, wherein the upper and lower isolating annuli are configured to create the controlled axial thrust load on the double suction impeller which typically has no substantial hydraulic thrust load in the direction of the axis of rotation.

4. Apparatus according to claim 1, wherein the metal rims are configured to be located at a minimum trim value in relation to the outside diameter of the double suction impeller.

5. Apparatus according to claim 1, wherein the upper and lower isolating annuli or rings are configured to form an isolated section of the upper or lower shrouds extending at least partly towards the shaft.

6. Apparatus according to claim 1, wherein the metal rims are configured to extend substantially completely around the upper or lower shrouds.
